(19) United States
(12) Patent Application Publication
(10) Pub. No.: US 2024/0250493 A1
(43) Pub. Date: Jul. 25, 2024

(54) HIGH BRIGHTNESS PUMP-SIGNAL COMBINER WITH BIDIRECTIONALLY TAPERED SIGNAL FIBER

(71) Applicant: Lumentum Operations LLC, San Jose, CA (US)

(72) Inventors: Gongwen ZHU, San Jose, CA (US); Matthew KUTSURIS, Dublin, CA (US); Guan SUN, San Jose, CA (US); Ning LIU, Morgan Hill, CA (US)

(21) Appl. No.: 18/193,195

(22) Filed: Mar. 30, 2023

Related U.S. Application Data
(60) Provisional application No. 63/481,110, filed on Jan. 23, 2023.

(51) Int. Cl. H01S 3/094; G02B 6/42; H01S 3/0941; H01S 3/23

(52) U.S. Cl. CPC H01S 3/094053; G02B 6/4202; G02B 6/4262; H01S 3/094007; H01S 3/094011; H01S 3/09415; H01S 3/2308; H01S 3/067

(57) ABSTRACT

In some implementations, a pump-signal combiner may comprise a plurality of pump fibers configured to receive pump light and to transmit the pump light into a cladding of an output fiber and one or more signal fibers, surrounded by the plurality of pump fibers. In some implementations, the one or more signal fibers may each comprise an input section, coupled to the one or more first laser sources, having an input core diameter; an output section, coupled to the output fiber, having an output core diameter; a first tapered section, adjacent to the input section, in which a core diameter increases from the input core diameter to a maximum value; and a second tapered section, adjacent to the output section, in which a core diameter decreases from the maximum value to the output core diameter.

### CROSS-REFERENCE TO RELATED APPLICATION

This Patent Application claims priority to U.S. Provisional Patent Application No. 63/481,110, filed on Jan. 23, 2023, and entitled “HIGH-BRIGHTNESS PUMP AND SIGNAL COMBINER WITH BIDIRECTIONALLY TAPERED SIGNAL FIBER.” The disclosure of the prior Application is considered part of and is incorporated by reference into this Patent Application.

### TECHNICAL FIELD

The present disclosure relates generally to a high power fiber laser and to a pump-signal combiner that may be used in a high power fiber laser to inject pump light at different locations along an active fiber length.

### BACKGROUND

Pump-signal combiners are critical components of high-power fiber lasers. A pump-signal combiner combines pump light and signal light to increase a power of the signal light.

SUMMARY

In some implementations, a pump-signal combiner includes a glass enclosure; and a fiber bundle disposed within the glass enclosure, wherein the fiber bundle comprises: a plurality of pump fibers; and a signal fiber, surrounded by the plurality of pump fibers, that comprises: an input section having an input core diameter; an output section having an output core diameter; and an intermediate section, provided between the input section and the output section, wherein the intermediate section comprises: a first tapered section, adjacent to the input section, in which a core diameter of the intermediate section increases from the input core diameter to a maximum value; and a second tapered section, adjacent to the output section, in which the core diameter of the intermediate section decreases from the maximum value to the output core diameter.

In some implementations, a method for fabricating a pump-signal combiner includes inserting a fiber bundle into a glass enclosure that comprises a first waist sized to fit the fiber bundle, wherein the fiber bundle comprises: a plurality of pump fibers; and a signal fiber, surrounded by the plurality of pump fibers, that comprises: an input section having an input core diameter; and a first tapered section, adjacent to the input section, in which a core diameter increases from the input core diameter to a maximum value; tapering a portion of the glass enclosure and a portion of the fiber bundle disposed within the glass enclosure, wherein tapering the portion of the glass enclosure and the portion of the fiber bundle disposed within the glass enclosure causes the signal fiber to further comprise: an output section having an output core diameter; and a second tapered section, adjacent to the output section, in which a core diameter decreases from the maximum value to the output core diameter; cleaving the fiber bundle at the first waist; and splicing the fiber bundle to an output fiber.

In some implementations, an optical system includes an input subsystem comprising: one or more first laser sources configured to generate signal light; and a plurality of second laser sources configured to generate pump light; an output fiber comprising one or more cores configured to carry the signal light and a cladding, surrounding the core, configured to carry the pump light; and a pump-signal combiner, arranged between the input subsystem and the output fiber, wherein the pump-signal combiner comprises: a plurality of pump fibers configured to receive the pump light and to transmit the pump light into the cladding of the output fiber; and one or more signal fibers, surrounded by the plurality of pump fibers, wherein the one or more signal fibers each comprise: an input section, coupled to the one or more first laser sources, having an input core diameter; an output section, coupled to the output fiber, having an output core diameter; a first tapered section, adjacent to the input section, in which a core diameter increases from the input core diameter to a maximum value; and a second tapered section, adjacent to the output section, in which a core diameter decreases from the maximum value to the output core diameter.

### BRIEF DESCRIPTION OF THE DRAWINGS

FIGS. 1A-1B illustrate an example implementation of a pump-signal combiner that includes a bidirectionally tapered signal fiber.

FIGS. 2A-2D illustrate an example implementation of a process for fabricating a pump-signal combiner that includes a bidirectionally tapered signal fiber.

FIG. 3 illustrates an example implementation of an optical system that includes a pump-signal combiner that includes a bidirectionally tapered signal fiber.

FIG. 4 is a flowchart of an example process associated with fabricating a pump-signal combiner that includes a bidirectionally tapered signal fiber.

### DETAILED DESCRIPTION

The following detailed description of example implementations refers to the accompanying drawings. The same reference numbers in different drawings may identify the same or similar elements.

Pump-signal combiners are critical components of high-power fiber lasers. For example, a pump-signal combiner generally combines pump light to create combined pump light with an increased power. In many cases, pump combiners are arranged in a bundle configuration, which is spliced to another optical structure (e.g., a master oscillator power amplifier (MOPA) and/or a single pass fiber laser structure) that is configured to deliver many hundreds of watts (W)/kilowatts (kW) of pump power. A bundle configuration can be achieved by arranging pump fibers into a particular close-packed configuration (e.g., a hexagonal close-packing configuration or the like), and fusing and tapering individual pump fibers into a bundle of a target size. Furthermore, in a pump-signal combiner, a signal fiber is included with the individual pump fibers in the bundle. In this way, the various pump fibers can be used to couple pump power from multiple pump sources into a cladding of an output fiber, and signal light can propagate through a core of the signal fiber included in the pump-signal combiner and into a core of the output fiber. However, one challenge that arises in designing and fabricating pump-signal combiners is that the various fibers in the bundle need to be tapered to match the output fiber. For example, if the various fibers in the bundle were not tapered, the total area of the fiber bundle would be much larger than the output fiber.

Consequently, when a fusing and tapering process is performed on the bundle (e.g., to fuse and taper the various pump fibers), the signal fiber is fused to the pump fibers and the signal fiber is also tapered together with the pump fibers. This often results in a signal fiber that is significantly reduced in size (e.g., from one end of the bundle to another end of the bundle), which can result in perturbance, or other distortion, of a signal beam that propagates through the signal fiber (e.g., end-to-end of the bundle). Further, the signal beam can leak out of the signal fiber core at a tapered area of the signal fiber (e.g., due to a decreased size of the signal fiber core). Additionally, the size of the signal fiber core inside the tapered bundle often mismatches a size of an output fiber core (e.g., to which the signal fiber core is to be spliced). This increases an amount of the signal beam that leaks out of the signal fiber core, which reduces brightness, increases optical loss of the signal beam, and/or generates heat within the pump combiner. Accordingly, performance (e.g., an optical performance and/or a thermal performance) of the pump combiner is impacted.

In some implementations, as described herein, a high-brightness pump-signal combiner may comprise a plurality of pump fibers configured to receive pump light and to transmit the pump light into a cladding of an output fiber, and one or more signal fibers, surrounded by the plurality of pump fibers, where the one or more signal fibers each comprise an input section, coupled to a laser source, having an input core diameter, an output section, coupled to the output fiber, having an output core diameter, and a bidirectionally tapered intermediate section. For example, the bidirectionally tapered intermediate section may include a first tapered section (e.g., an up-taper section), adjacent to the input section, in which a core diameter increases from the input core diameter to a maximum value, and a second tapered section (e.g., a down-taper section), adjacent to the output section, in which the core diameter decreases from the maximum value to the output core diameter. In some implementations, as described herein, the high-brightness pump-signal combiner may be used to inject pump light at different locations along an active fiber length to scale up the power of a kilowatt (kW) fiber laser without causing significant signal core power loss or beam quality degradation. For example, the high-brightness pump-signal combiner may include two tapered sections for an intermediate signal fiber, while keeping the intermediate signal fiber (e.g., including the two tapered sections) within tens of millimeters. As described herein, the design with the bidirectionally tapered intermediate signal fiber may allow a relatively high tapering ratio for the signal fiber and may significantly reduce signal degradation, even in cases where there are a large number of pump fibers.

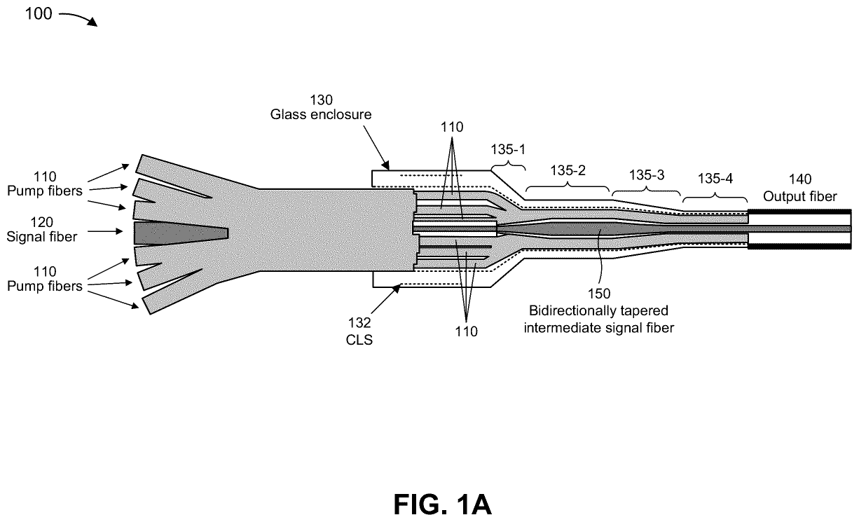

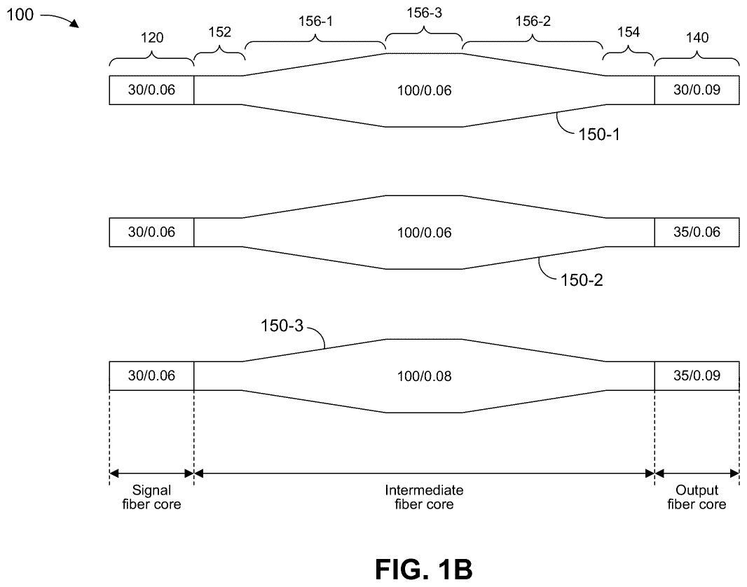

FIGS. 1A-1B illustrates an example implementation 100 of a pump-signal combiner that includes a bidirectionally tapered intermediate signal fiber 150. For example, as shown in FIG. 1A, the pump-signal combiner may include a plurality of pump fibers 110 that are arranged or configured to receive pump light from respective pump sources (e.g., laser diodes), and an intermediate signal fiber 150 arranged or configured to receive signal light from a signal light source (e.g., a laser light source, not shown). In some implementations, the signal light may generally propagate to the intermediate signal fiber 150 included in the pump-signal combiner via an input signal fiber 120 of an input component (e.g., an oscillator, an amplifier, a mode field adapter (MFA), or another suitable optical component). As further shown in FIG. 1A, the pump-signal combiner may include a glass enclosure 130. Alternatively, as described in further detail herein, the pump-signal combiner may not include any glass enclosure 130. Furthermore, the pump-signal combiner may be coupled to an output fiber 140, which includes a core that is coupled to the intermediate signal fiber 150 of the pump-signal combiner and a cladding that is coupled to the pump fibers 110 of the pump-signal combiner.

Accordingly, in some implementations, the pump fibers 110 may be configured to propagate pump light, such that the pump light carried in the pump fibers 110 is to combine with the signal beam propagating in the intermediate signal fiber 150. Portions of the pump light may be respectively emitted by multiple pump light sources (e.g., a plurality of laser light sources, not shown) and may respectively propagate via the multiple pump fibers 110 to combine with the signal beam. The signal beam (e.g., after combining with the pump light) may emit from the intermediate signal fiber 150 and/or the pump-signal combiner to propagate to a core of the output fiber 140, which may be included in an output component or coupled between the pump-signal fiber and the output component (e.g., an oscillator, an amplifier, an MFA, or the like).

In some implementations, the glass enclosure 130 may be a capillary tube, which is a hollow, open-ended glass tube. Accordingly, an internal portion of the capillary tube may be defined by a space within the capillary tube, such as a space between internal surfaces of one or more walls of the capillary tube. In some implementations, the intermediate signal fiber 150 and the plurality of pump fibers 110 may be disposed within the internal portion of the capillary tube (e.g., a fiber bundle that includes the intermediate signal fiber 150 and the plurality of pump fibers 110 surrounding the intermediate signal fiber 150 may be inserted into and may fill the internal portion of the capillary tube). In some implementations, as shown in FIG. 1A, a cladding light stripper (CLS) 132 may be provided on the glass enclosure 130. For example, in some pump configurations (e.g., backward pumping, where signal light travels from the output fiber 140 to the input signal fiber 120 and pump light travels in the opposite direction), there may be significant residual pump light and signal light in a cladding the output fiber 140. In such cases, some of the residual pump light and signal light in the cladding of the output fiber 140 may reach a coating or adhesive on the glass enclosure 130, which may cause the glass enclosure 130 to heat up and is the main source of light in the glass enclosure 130. Accordingly, in some implementations, the CLS 132 may be provided to remove the cladding light before the cladding light reaches the coating or adhesive on the glass enclosure 130.

In some implementations, the plurality of pump fibers 110, the input signal fiber 120, the glass enclosure 130, the output fiber 140, and the intermediate signal fiber 150 may each comprise glass (e.g., a silica-based glass, a quartz-based glass, a fluorinated glass, or another type of glass). In some implementations, the pump fibers 110, the input signal fiber 120, the glass enclosure 130, the output fiber 140, and the intermediate signal fiber 150 may comprise the same glass types or different glass types. In some implementations, the intermediate signal fiber 150 and the multiple pump fibers 110 may include a fiber core and a fiber cladding. For example, the intermediate signal fiber 150 and the multiple pump fibers 110 may each include a fiber core that is circumferentially surrounded by a fiber cladding. Alternatively, in some implementations, the intermediate signal fiber 150 may not have a fiber cladding (e.g., the intermediate signal fiber 150 may comprise only a fiber core), or the intermediate signal fiber 150 may have a fiber cladding with a fiber cladding thickness that is different than respective fiber cladding thicknesses of the fiber claddings of the pump fibers 110. For example, the intermediate signal fiber 150 may have a fiber cladding with a fiber cladding thickness that is less than respective fiber cladding thicknesses of the fiber claddings of the pump fibers 110. In some implementations, the pump fibers 110 and the intermediate signal fiber 150 may be arranged, within the glass enclosure 130, in a bundle configuration.

Additionally, or alternatively, in some implementations, the pump-signal combiner may include a design without a glass enclosure 130. For example, rather than feeding the fiber bundle that includes the intermediate signal fiber 150 and the pump fibers 110 into a glass enclosure 130, and then tapering the glass enclosure 130 to match the core and cladding size of the output fiber 140, the pump fibers 110 and the intermediate signal fiber 150 may be twisted, tapered, fused, and spliced to the output fiber 140 (e.g., such that the intermediate signal fiber 150 transmits signal light into the core of the output fiber 140 and the pump fibers 110 transmit pump light into the cladding of the output fiber 140). Furthermore, although some implementations are described herein with respect to a pump-signal combiner that includes a fiber bundle with one intermediate signal fiber 150 surrounded by a plurality of pump fibers 110, the fiber bundle may include multiple intermediate signal fibers 150 that are surrounded by a plurality of pump fibers 110. For example, in some implementations, the output fiber 140 may generally include one or more cores, and each core in the output fiber 140 may be matched to one corresponding intermediate signal fiber 150 in the fiber bundle of the pump-signal fiber. For example, each fiber in the fiber bundle may support transmitting either signal light or cladding (e.g., pump) light, whereby each fiber in the fiber bundle may be used as an intermediate signal fiber 150 or a pump fiber 110. For example, in a fiber bundle that includes a central fiber surrounded by six other fibers, the central fiber may be configured as the intermediate signal fiber 150 and the six surrounding fibers may be configured as pump fibers 110 in a design where the output fiber 140 includes a single core. Alternatively, in a design where the output fiber 140 includes three cores, the fiber bundle may include three fibers that are configured as intermediate signal fibers 150 and four fibers that are configured as pump fibers 110. In this way, in any given fiber bundle, a plurality of the fibers are configured as pump fibers 110 and one or more of the fibers are configured as intermediate signal fibers 150 to create a single-core pump-signal combiner (e.g., with one intermediate signal fiber 150) or a multicore pump-signal combiner (e.g., with multiple intermediate signal fibers 150).

In some implementations, as shown in FIG. 1B, the intermediate signal fiber 150 may be coupled between a core of the input signal fiber 120, which has a first core diameter and a first numerical aperture (NA), and a core of the output fiber 140, which has a second core diameter and a second NA. As further shown in FIG. 1B, the intermediate signal fiber 150 may include an input section 152 that has a first (e.g., input) core diameter and a first NA matched to the core of the input signal fiber 120, an output section 150 that has a second (e.g., output) core diameter and a second NA matched to the core of the output fiber 140, and a bidirectionally tapered intermediate section 156 provided between the input section 152 and the output section 154 to reduce degradation of the signal light that propagates or is otherwise carried in the intermediate signal fiber 150. For example, in some implementations, the input section 152, the output section 154, and the bidirectionally tapered intermediate section 156 may be provided within the pump-signal combiner structure (e.g., within the glass enclosure 130). Alternatively, in cases where the pump fibers 110 and the intermediate signal fiber(s) 150 are twisted and a fused tapering is applied to the pump fibers 110 and the intermediate signal fiber(s) 150, there may be no glass enclosure 130 surrounding the input section 152, the output section 154, and the bidirectionally tapered intermediate section 156. In either case, as shown in FIG. 1B, the bidirectionally tapered intermediate section 156 may include an up-tapered section 156-1 adjacent to the input section 152 of the intermediate signal fiber 150 and a down-tapered section 156-2 adjacent to the output section 154 of the intermediate signal fiber 150. For example, the up-tapered section 156-1 may have a core diameter that increases (e.g., up-tapers adiabatically) from the core diameter of the input section 152 to a maximum value, and the down-tapered section 156-2 may have a core diameter that decreases (e.g., down-tapers adiabatically) from the maximum value to the core diameter of the output section 154.

In some implementations, as described herein, the up-tapered section 156-1 and the down-tapered section 156-2 may be provided to increase a core size (e.g., core diameter) of the intermediate signal fiber 150 and/or to increase the NA of the intermediate signal fiber 150. For example, when the pump fibers 110 and the intermediate signal fiber 150 are tapered to match the core and the cladding of the output fiber 140, the taper will generally introduce some degradation (e.g., caused by higher-order modes) due to imperfections in the tapering process. Furthermore, because a larger core size generally supports more higher-order modes, the signal light may excite more higher-order modes when the signal light travels from the core of the input signal fiber 120 to the intermediate signal fiber 150. The core of the output fiber 140 therefore needs to have a larger core diameter and/or a higher NA than the core of the input signal fiber 120 to prevent loss of the higher-order modes. Accordingly, as described herein, the up-tapered section 156-1 and the down-tapered section 156-2 may be provided to increase the core size and/or the NA of the intermediate signal fiber 150 between the input section 152 and the output section 154 in order to address the potential degradation (e.g., loss of higher-order modes) that otherwise occur within the pump-signal combiner (e.g., whether tapered within the glass enclosure 130 or using a twist and fusing technique). For example, FIG. 1B depicts a first example of the bidirectionally tapered intermediate signal fiber 150-1, where signal light is traveling from left to right, and the up-tapered section 156-1 and the down-tapered section 156-2 are provided to go from a core diameter of 30 microns and an NA of 0.06 in the input section 152 to a core diameter of 30 microns and an NA of 0.09 in the output section 154 (e.g., increasing the NA).

Additionally, or alternatively, FIG. 1B depicts a second example of the bidirectionally tapered intermediate signal fiber 150-2, where signal light is again traveling from left to right, and the up-tapered section 156-1 and the down-tapered section 156-2 are provided to go from a core diameter of 30 microns and an NA of 0.06 in the input section 152 to a core diameter of 35 microns and an NA of 0.06 in the output section 154 (e.g., increasing the core diameter). In examples 150-1 and 150-2, the up-tapered section 156-1 and the down-tapered section 156-2 taper up to or taper down from a core diameter of 100 microns and an NA of 0.06. Additionally, or alternatively, FIG. 1B depicts a third example of the bidirectionally tapered intermediate signal fiber 150-3, where signal light is again traveling from left to right, the up-tapered section 156-1 and the down-tapered section 156-2 are provided to go from a core diameter of 30 microns and an NA of 0.06 to a core diameter of 35 microns and an NA of 0.09 (e.g., increasing the core diameter and the NA), and the up-tapered section 156-1 and the down-tapered section 156-2 are associated with an NA that is between the NA of the input section 152 and the NA of the output section 154. In this way, the bidirectionally tapered intermediate section 150 of the signal fiber 120 may be fabricated such that the end of the up-tapered section 156-1 adjacent to the input section 152 equals the core diameter and NA of the input section 152 and such that the end of the down-tapered section 156-2 adjacent to the output section 154 equals the core diameter and NA of the output section 154. In this way, the high-brightness pump-signal combiner with the bidirectionally tapered intermediate signal fiber 150 may be spliced to the output fiber 140, which may be spliced to an active fiber in a MOPA structure or other suitable optical device, allowing for high power forward, cascaded, and/or backward pumping through the active fiber. Furthermore, using the bidirectionally tapered intermediate signal fiber 150 to increase the core diameter and/or the NA between the input signal fiber 120 the output fiber 140 may compensate for degradation caused by the taper (e.g., increased higher-order modes and/or beam parameter product (BPP)).

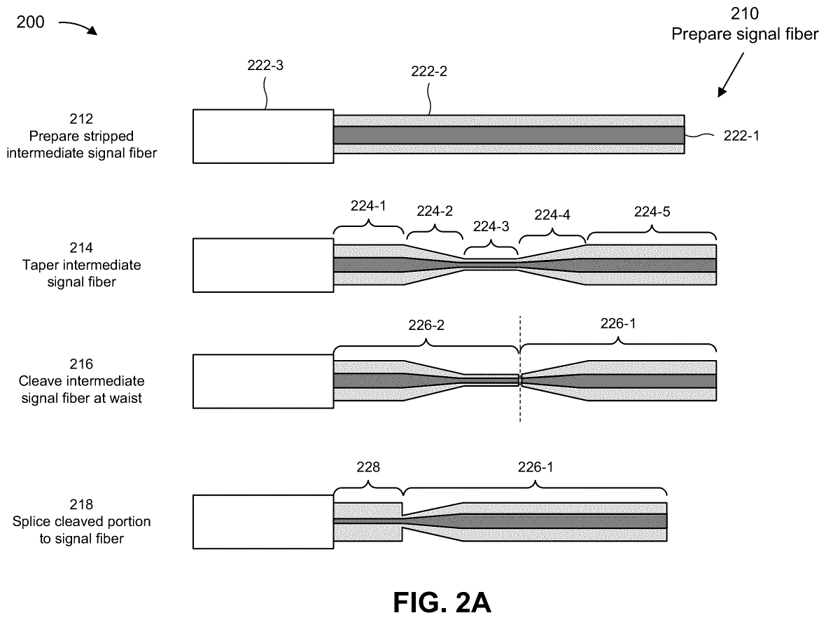

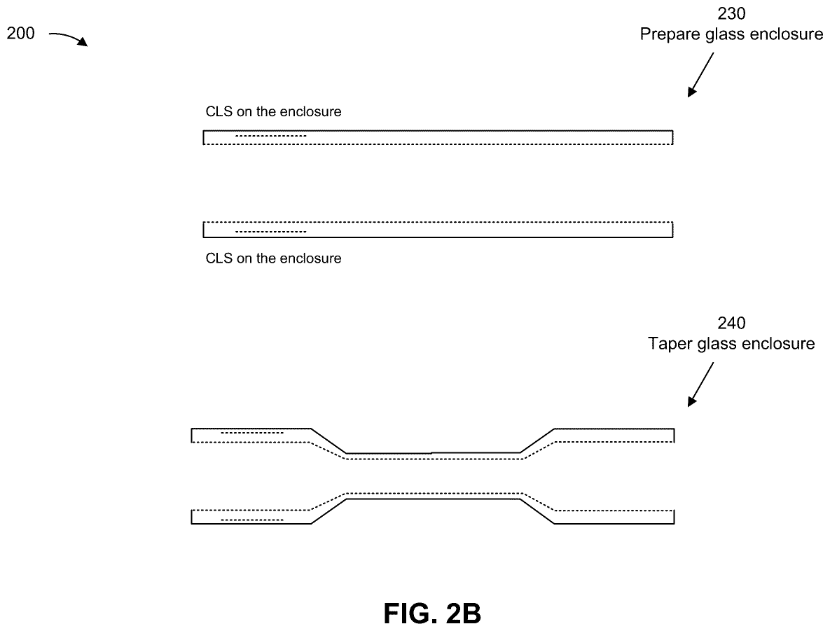

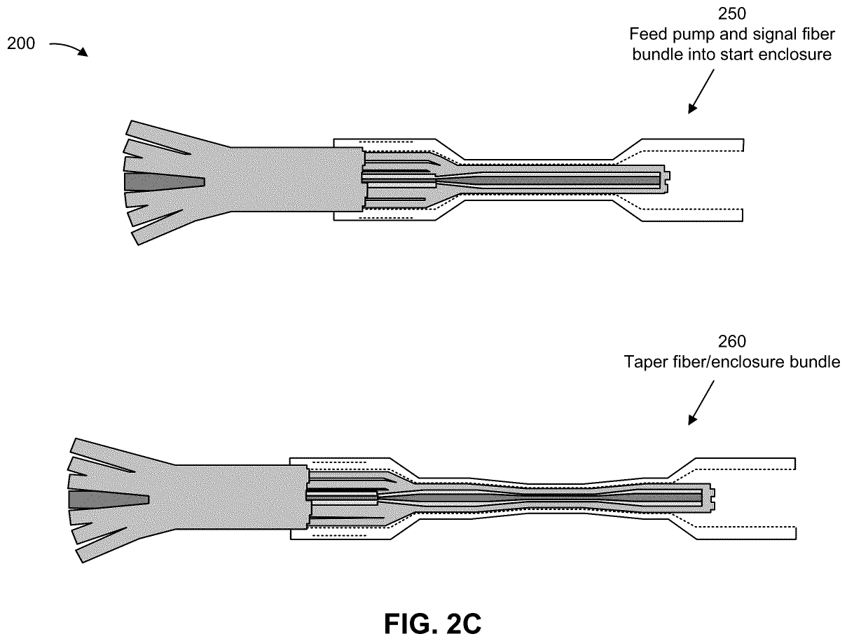

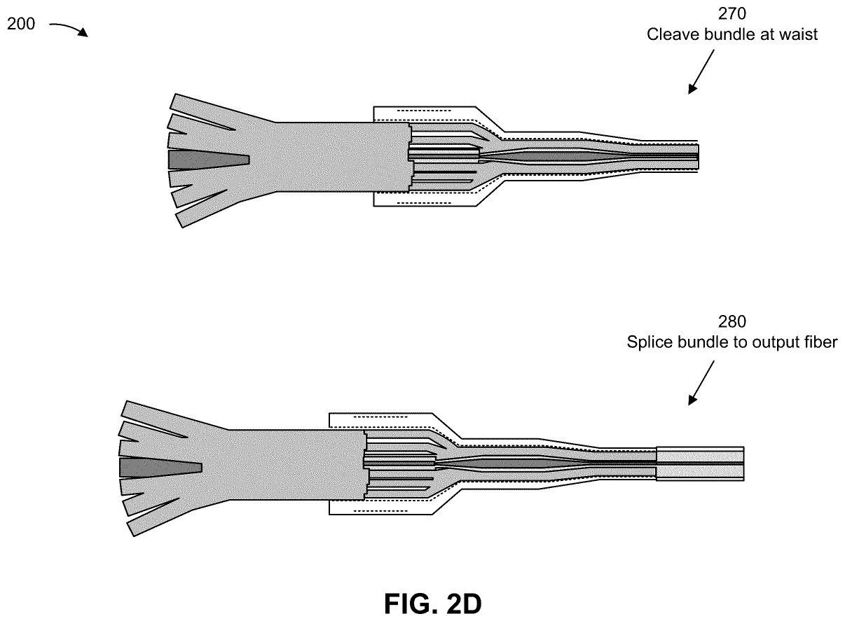

In some implementations, as further shown in FIG. 1B, the bidirectionally tapered intermediate section 156 may include a central section 156-3, provided between the up-tapered section 156-1 and the down-tapered section 156-2, with a uniform core diameter equal to the maximum value of the core diameter for the up-tapered section 156-1 and the down-tapered section 156-2. For example, in some implementations, providing the central section 156-3 between the up-tapered section 156-1 and the down-tapered section 156-2 may simplify a process to fabricate the bidirectionally tapered intermediate signal fiber 150 (e.g., as described in further detail herein with respect to FIGS. 2A-2D). Alternatively, in some implementations, the bidirectionally tapered intermediate signal fiber 150 may not include the central section 156-3, and the up-tapered section 156-1 and the down-tapered section 156-2 may overlap to some degree. For example, instead of tapering a 100 micron fiber in two directions to form the up-tapered section 156-1 and the down-tapered section 156-2, as in an implementation in which the bidirectionally tapered intermediate signal fiber 150 includes the central section 156-3, the maximum value of the core diameter may be 80 microns in an implementation in which the bidirectionally tapered intermediate signal fiber 150 does not include the central section 156-3.

In some implementations, as shown in FIG. 1A, the glass enclosure 130 may be a capillary tube that includes an input end and an output end, where the output end includes a first section 135-1 (e.g., a first down-tapered section), a second section 135-2, a third section 135-3 (e.g., a second down-tapered section), and a fourth section 135-4. Accordingly, in cases where the pump-signal combiner includes the glass enclosure 130, the various pump fibers 110 and the bidirectionally tapered intermediate signal fiber(s) 150 included in the pump-signal combiner may be arranged in a non-fused bundle configuration within the input end of the glass enclosure 130, the first section 135-1 of the output end, and the second section 135-2 of the output end (e.g., each of the plurality of pump fibers 110 and the intermediate signal fiber(s) 150 may be separate and distinct from each other within the input end of the glass enclosure 130, the first section 135-1 of the output end, and the second section 135-2 of the output end). Furthermore, in some implementations, the first section 135-1 of the output end (e.g., the first down-tapered section) of the glass enclosure 130 may at least partially overlap with the up-tapered section 156-1 of the intermediate signal fiber 150.

In some implementations, in the third section 135-3 of the output end (e.g., the second down-tapered section) of the glass enclosure 130, the plurality of pump fibers 110 and the intermediate signal fiber(s) 150 may be arranged in a partially fused bundle configuration (e.g., the fiber claddings of the pump fibers 110 may be joined together within the third section 135-3 to form a unified bundle of pump fibers 110 with one or more gaps between fiber claddings of the bundled pump fibers 110). Within the third section 135-3, the pump fibers 110 may taper along the length of the third section 135-3, from a non-fused bundle configuration, to a partially fused bundle with the pump fibers 110 becoming more closely fused and the gaps becoming smaller, to a fully fused unified bundle (e.g., without gaps between fiber claddings of the plurality of pump fibers 110). Additionally, in the fourth section 135-4 of the output end of the glass enclosure 130, the pump fibers 110 may be arranged in a fused bundle configuration (e.g., the fiber claddings of the plurality of pump fibers 110 may be joined together to form a unified bundle of pump fibers 110). Furthermore, in some implementations, the third section 135-3 of the output end (e.g., the second down-tapered section) of the glass enclosure 130 may at least partially overlap with the down-tapered section 156-2 of the intermediate signal fiber 150.

Furthermore, in some implementations, a portion of the glass enclosure 130 may be etched (e.g., using one or more etching techniques, such as a wet etching technique, a reactive ion etching technique and/or another etching technique) to increase brightness of the pump light carried in the pump fibers 110 and the signal light carried in the signal fiber(s) 120. For example, in some implementations, the glass enclosure 130 may be etched away (e.g., in the fourth section 135-4 of the output end), and the intermediate signal fiber(s) 150 and the fused bundle of pump fibers 110 may then be spliced to the output fiber 140. For example, etching away the glass enclosure 130 at or near the splice point with the output fiber 140 may increase the brightness of the pump light and the signal light by enabling a smaller taper ratio, which may better preserve a BPP value. For example, if the bidirectionally tapered intermediate signal fiber 150 were to increase from 30 microns to 50 microns and then decrease from 50 microns back to 30 microns, the brightness degradation would be less than in a design in which the bidirectionally tapered intermediate section 150 increases from 30 microns to 100 microns and then decreases from 100 microns back to 30 microns (e.g., a lower taper ratio generally provides less brightness degradation). Accordingly, if a portion of the glass enclosure 130 at or near the splice point with the output fiber 140 is etched away, the taper ratio may be reduced because the output fiber 140 typically has a fixed diameter and less tapering needs to be done to match the size of the output fiber 140.

As indicated above, FIGS. 1A-1B are provided as an example. Other examples may differ from what is described with regard to FIGS. 1A-1B. The number and arrangement of devices shown in FIGS. 1A-1B are provided as an example. In practice, there may be additional devices, fewer devices, different devices, or differently arranged devices than those shown in FIGS. 1A-1B. Furthermore, two or more devices shown in FIGS. 1A-1B may be implemented within a single device, or a single device shown in FIGS. 1A-1B may be implemented as multiple, distributed devices. Additionally, or alternatively, a set of devices (e.g., one or more devices) shown in FIGS. 1A-1B may perform one or more functions described as being performed by another set of devices shown in FIGS. 1A-1B.

FIGS. 2A-2D illustrate an example implementation 200 of a process for fabricating a pump-signal combiner that includes a bidirectionally tapered signal fiber.

For example, referring to FIG. 2A, reference number 210 illustrates a multi-step process that may be used to prepare the signal fiber to be included in the high-brightness pump-signal combiner. In a first step, as shown by reference number 212, a stripped intermediate signal fiber may be prepared. For example, as shown in FIG. 2A, the signal fiber may include a core 222-1, a cladding 222-2 that surrounds the core 222-1, and a coating 222-3 that surrounds the cladding 222-2. Accordingly, in the first step, a portion of the coating 222-3 may be removed (e.g., by etching or any other suitable technique) to prepare the stripped intermediate signal fiber. As further shown in FIG. 2A, in a second step, shown by reference number 214, the stripped intermediate signal fiber may be tapered to appropriate dimensions.

For example, in FIG. 2A, the intermediate signal fiber is tapered such that the stripped portion of the intermediate signal fiber includes a first section 224-1 and a fifth section 224-5 with the original dimensions for the core 222-1 and the cladding 222-2 (e.g., corresponding to the maximum diameter of the final intermediate signal fiber). As further shown, between the first section 224-1 and the fifth section 224-5, the intermediate signal fiber includes a second (e.g., down-tapered) section 224-2, a third (e.g., central) section 224-3 with a uniform core diameter, and a fourth (e.g., up-tapered) section 224-4. In some implementations, the uniform core diameter of the central section 224-3 may equal the core diameter of an input signal fiber to which the intermediate signal fiber is to be spliced.

In some implementations, in a third step, as shown by reference number 216, the tapered intermediate signal fiber may be cleaved at a taper waist. For example, the taper waist may refer to a location where the tapered intermediate signal fiber has a minimum diameter, shown by a dashed line in FIG. 2A. Accordingly, cleaving the tapered intermediate signal fiber at the taper waist may separate the tapered intermediate signal fiber into a first section 226-1 and a second section 226-2. In some implementations, the second section 226-2 may be discarded. Accordingly, in a fourth step, as shown by reference number 218, the first section 226-1 of the tapered intermediate signal fiber may be spliced to an input signal fiber 228. The resulting signal fiber may then be combined with a plurality of pump fibers in a fiber bundle.

Additionally, or alternatively, the intermediate signal fiber can be pre-tapered or pre-etched. For example, if the diameter of the cladding 222-2 of the intermediate signal fiber is larger than needed for a particular system, the intermediate signal fiber can be pre-etched or pre-tapered and then further tapered. For example, in a design where a fiber bundle includes a central signal fiber that is surrounded by an inner ring including 8 pump fibers and an outer ring including an additional 14 pump fibers, there would be gaps between the pump fibers and packing within the fiber bundle would be insufficiently compact if the intermediate signal fiber to be used as the central signal fiber is too large. Accordingly, in cases where the size of the signal fiber is too large for a particular design, the signal fiber can be etched down or pre-tapered down to a desired size (e.g., based on a particular packing geometry for the fiber bundle).

As shown in FIG. 2B, a glass enclosure may be prepared for cases where the pump-signal combiner includes a glass enclosure (e.g., a capillary tube). For example, as shown by reference number 230, preparing the glass enclosure may include selecting and/or preparing a capillary tube with a particular size (e.g., a particular inner diameter and/or a particular outer diameter) such that a fiber bundle that includes the tapered intermediate signal fiber and a plurality of pump fibers are able to be inserted into an internal portion of the capillary tube (e.g., when the tapered intermediate signal fiber and the plurality of pump fibers are arranged in a non-fused bundle configuration). For example, the process may include selecting and/or preparing a capillary tube with an inner diameter that is greater than an outer diameter of the fiber bundle that includes the tapered intermediate signal fiber and the plurality of pump fibers arranged in the non-fused bundle configuration. Furthermore, as shown in FIG. 2B, preparing the glass enclosure may include forming a CLS on the glass enclosure (e.g., using a carbon dioxide (CO₂) laser, a glass etching cream, and/or other suitable techniques). As further shown in FIG. 2B, and by reference number 240, the glass enclosure may be tapered to form a starting tube structure (e.g., a “start enclosure”). For example, to taper the glass enclosure, heat and/or a force (e.g., a tensile force) may be applied to a central portion of the glass enclosure, which may cause the capillary to have a waist. The waist may have an inner diameter that is less than the inner diameter of the end portions of the glass enclosure that are not tapered and is greater than the outer diameter of the fiber bundle that includes the tapered intermediate signal fiber and the plurality of pump fibers.

As shown in FIG. 2C, and by reference number 250, a fiber bundle that includes a plurality of pump fibers and one or more signal fibers that are formed as described above with reference to FIG. 2A may be fed into the start enclosure that is formed as described above with reference to FIG. 2B. For example, the fiber bundle may be fed into the tapered glass enclosure such that the plurality of pump fibers and the signal fiber(s) included in the fiber bundle are inserted into the waist of the glass enclosure. In this way, the plurality of pump fibers and the signal fiber(s) may be disposed within the glass enclosure and the waist of the glass enclosure. Additionally, the plurality of pump fibers and the signal fiber(s) may be arranged in a non-fused bundle configuration when disposed within the waist of the glass enclosure.

As further shown in FIG. 2C, and by reference number 260, the glass enclosure and the fiber bundle disposed within the glass enclosure may then be tapered down to desired dimensions. For example, heat and/or a force (e.g., a tensile force) may be applied to one or more portions of the glass enclosure, within which the plurality of pump fibers and the intermediate signal fiber(s) are disposed. In a particular example, as shown in FIG. 2C, one or more portions of the waist of the glass enclosure are tapered, which causes one or more corresponding portions of the plurality of pump fibers and the signal fiber(s) disposed within the tapered portion(s) of the glass enclosure to be tapered. In some implementations, as a result of the tapering, the waist and the one or more corresponding portions of the plurality of pump fibers may fuse to form a partially fused bundle arrangement or a fully fused bundle arrangement.

As shown in FIG. 2D, and by reference number 270, the glass enclosure and the tapered fiber bundle disposed within the glass enclosure may be cleaved at a cleave point along the waist of the glass enclosure. In this way, an output end of the pump-signal combiner may be formed. Furthermore, in some implementations, a portion of the glass enclosure may be etched (e.g., using one or more etching techniques, such as a wet etching technique, a reactive ion etching technique and/or another etching technique). For example, the portion of the glass enclosure that is etched may be a portion of the glass enclosure that includes the output end of the glass enclosure. Notably, etching the portion of the glass enclosure may not affect a portion of the fiber bundle disposed within the etched portion of the glass enclosure (e.g., the portion of the fiber bundle disposed within the etched portion of the glass enclosure is not etched).

As further shown in FIG. 2D, and by reference number 280, the bundle may then be spliced to the output fiber, which may include a core to receive signal light that propagates in the bidirectionally tapered intermediate signal fiber and a cladding, surrounding the core, to receive pump light that propagates in the plurality of pump fibers that surround the bidirectionally tapered intermediate signal fiber. In some implementations, after splicing the bundle to the output fiber, the pump-signal combiner may be properly packaged. Furthermore, in some implementations, the output fiber may be etched, tapered, or otherwise processed to the extent necessary for a given application prior to packaging the pump-signal combiner.

As indicated above, FIGS. 2A-2D are provided as an example. Other examples may differ from what is described with regard to FIGS. 2A-2D. For example, as described herein, the pump-signal combiner may be fabricated without a glass enclosure, in which case the fiber bundle may be twisted, fused, tapered, and spliced to the output fiber.

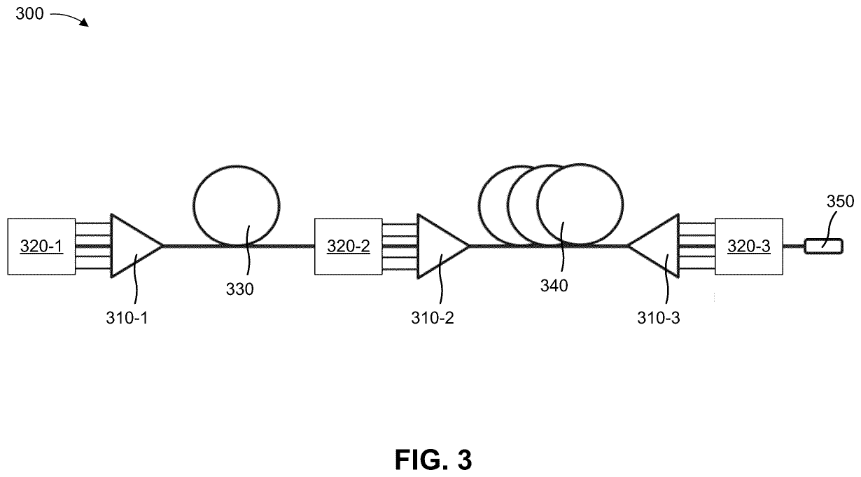

FIG. 3 illustrates an example implementation of an optical system 300 that includes one or more pump-signal combiners 310 with a bidirectionally tapered signal fiber (e.g., the pump-signal combiner described herein with respect to FIG. 1 and/or fabricated according to the process described herein with respect to FIGS. 2A-2D). As further shown in FIG. 3, the optical system may include one or more sets of laser sources 320, an oscillator 330, one or more amplifiers 340, and/or a laser output 350. In some implementations, the optical system 300 may include a MOPA configuration.

As shown in FIG. 3, a first set of laser sources 320-1 (e.g., corresponding to a first input subsystem) may include one or more laser sources configured to provide signal light and a plurality of laser sources configured to provide first pump light, where the signal light and the pump light is provided to a first pump-signal combiner 310-1 arranged between the first set of laser sources 320-1 and an output fiber in an end pumping or forward pumping configuration. For example, as described herein, the output fiber may include one or more cores configured to carry the signal light and a cladding, surrounding the core, configured to carry the pump light. Accordingly, the first pump-signal combiner 310 may combine the signal light and the pump light provided by the first set of laser sources 320-1 to form a first combined signal beam (e.g., in a similar manner as described elsewhere herein).

In some implementations, the first pump-signal combiner 310-1 may provide the first combined signal beam to the oscillator 330, which may provide the first combined signal beam to a second pump-signal combiner 310-2 (e.g., that is arranged in a cascaded pumping configuration). For example, as shown in FIG. 3, a second set of laser sources 320-2 may be configured to provide second pump light to the second pump-signal combiner 310-2, which may combine the first combined signal beam and the second pump light to form a second combined signal beam. The second pump-signal combiner 310-2 may provide the second combined signal beam to the one or more amplifiers 340, which may amplify the second combined beam and provide the second combined signal beam to a third pump-signal combiner 310-3 (e.g., that is arranged in a counter pumping or backward pumping configuration). For example, as shown in FIG. 3, a third set of laser sources 320-3 may be configured to provide third pump light (e.g., that propagates in an opposite direction of a propagation direction of the second combined signal beam) to the third pump-signal combiner 310-3, which may combine the second combined signal beam and the third pump light to form a third combined signal beam and provide the third combined signal beam to the laser output 350 (e.g., that may emit the third combined signal beam toward a target of the optical system 300).

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

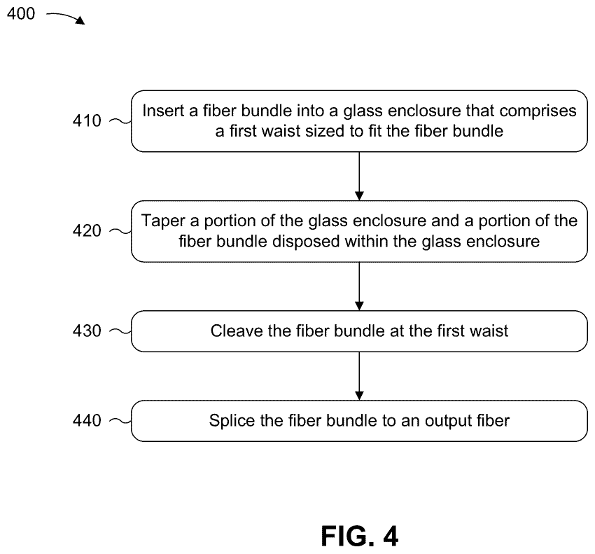

FIG. 4 is a flowchart of an example process 400 associated with fabricating a pump-signal combiner that includes a bidirectionally tapered signal fiber. In some implementations, one or more process blocks of FIG. 4 are performed by a fabrication system (e.g., a system configured to fabricate a pump-signal combiner according to the example process shown in FIGS. 2A-2D). In some implementations, one or more process blocks of FIG. 4 are performed by another device or a group of devices separate from or including the fabrication system (e.g., another system or sub-system configured to prepare a signal fiber having an up-tapered section, prepare a tapered capillary tube, or the like).

As shown in FIG. 4, process 400 may include inserting a fiber bundle into a glass enclosure that comprises a first waist sized to fit the fiber bundle, wherein the fiber bundle comprises: a plurality of pump fibers; and a signal fiber, surrounded by the plurality of pump fibers, that comprises: an input section having an input core diameter; and a first tapered section, adjacent to the input section, in which a core diameter increases from the input core diameter to a maximum value (block 410). For example, the fabrication system may insert a fiber bundle into a glass enclosure 130 that comprises a first waist sized to fit the fiber bundle, wherein the fiber bundle comprises: a plurality of pump fibers 110; and a signal fiber 150, surrounded by the plurality of pump fibers 110, that comprises: an input section 152 having an input core diameter; and a first tapered section 156-1, adjacent to the input section 152, in which a core diameter increases from the input core diameter to a maximum value, as described above.

As further shown in FIG. 4, process 400 may include tapering a portion of the glass enclosure and a portion of the fiber bundle disposed within the glass enclosure, wherein tapering the portion of the glass enclosure and the portion of the fiber bundle disposed within the glass enclosure causes the signal fiber to further comprise: an output section having an output core diameter; and a second tapered section, adjacent to the output section, in which a core diameter decreases from the maximum value to the output core diameter (block 420). For example, the fabrication system may taper a portion of the glass enclosure 130 and a portion of the fiber bundle disposed within the glass enclosure 130, wherein tapering the portion of the glass enclosure 130 and the portion of the fiber bundle disposed within the glass enclosure 130 causes the signal fiber 150 to further comprise: an output section 154 having an output core diameter; and a second tapered section 156-2, adjacent to the output section 154, in which a core diameter decreases from the maximum value to the output core diameter, as described above.

As further shown in FIG. 4, process 400 may include cleaving the fiber bundle at the first waist (block 430). For example, the fabrication system may cleave the fiber bundle at the first waist, as described above.

As further shown in FIG. 4, process 400 may include splicing the fiber bundle to an output fiber (block 440). For example, the fabrication system may splice the fiber bundle to an output fiber 140, as described above.

Process 400 may include additional implementations, such as any single implementation or any combination of implementations described below and/or in connection with one or more other processes described elsewhere herein.

In a first implementation, process 400 includes stripping an optical fiber that comprises a core surrounded by a cladding, wherein the core of the optical fiber has a diameter equal to the maximum value, tapering the optical fiber such that the optical fiber has a second waist in which a diameter of the core is reduced to match the input core diameter, cleaving the optical fiber at the second waist to form the first tapered section, and splicing the first tapered section to the input section to form the signal fiber.

In a second implementation, alone or in combination with the first implementation, process 400 includes forming a cladding light stripper on a surface of the glass enclosure, and tapering a central portion of the glass enclosure to form the first waist.

In a third implementation, alone or in combination with one or more of the first and second implementations, process 400 includes etching one or more portions of the glass enclosure.

In a fourth implementation, alone or in combination with one or more of the first through third implementations, the input core diameter is equal to the output core diameter, and the input section of the signal fiber and the output section of the signal fiber have different numerical apertures.

In a fifth implementation, alone or in combination with one or more of the first through fourth implementations, the input section of the signal fiber and the output section of the signal fiber have equal numerical apertures, and the input core diameter is different from the output core diameter.

In a sixth implementation, alone or in combination with one or more of the first through fifth implementations, the signal fiber further comprises an intermediate section, provided between the first tapered section and the second tapered section, having a uniform core diameter equal to the maximum value.

In a seventh implementation, alone or in combination with one or more of the first through sixth implementations, the glass enclosure comprises a capillary tube.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A pump-signal combiner, comprising:
a glass enclosure; and
a fiber bundle disposed within the glass enclosure, wherein the fiber bundle comprises:
a plurality of pump fibers; and
a signal fiber, surrounded by the plurality of pump fibers, that comprises:
an input section having an input core diameter;
an output section having an output core diameter; and
an intermediate section, provided between the input section and the output section, wherein the intermediate section comprises:
a first tapered section, adjacent to the input section, in which a core diameter of the intermediate section increases from the input core diameter to a maximum value; and
a second tapered section, adjacent to the output section, in which the core diameter of the intermediate section decreases from the maximum value to the output core diameter.

2. The pump-signal combiner of claim 1, wherein:
the input core diameter is equal to the output core diameter, and
the input section of the signal fiber and the output section of the signal fiber have different numerical apertures.

3. The pump-signal combiner of claim 1, wherein:
the input section of the signal fiber and the output section of the signal fiber have equal numerical apertures, and
the input core diameter is different from the output core diameter.

4. The pump-signal combiner of claim 1, wherein the intermediate section of the signal fiber further comprises:
an intermediate section, provided between the first tapered section and the second tapered section, having a uniform core diameter equal to the maximum value.

5. The pump-signal combiner of claim 1, wherein the output core diameter of the output section of the signal fiber equals a core diameter of an output fiber connected to the output section of the signal fiber.

6. The pump-signal combiner of claim 1, wherein the glass enclosure comprises a first tapered section that at least partially overlaps with the first tapered section of the signal fiber and a second tapered section that at least partially overlaps with the second tapered section of the signal fiber.

7. The pump-signal combiner of claim 1, wherein the glass enclosure comprises a capillary tube with a cladding light stripper on the capillary tube.

8. A method for fabricating a pump-signal combiner, comprising:
inserting a fiber bundle into a glass enclosure that comprises a first waist sized to fit the fiber bundle, wherein the fiber bundle comprises:
a plurality of pump fibers; and
a signal fiber, surrounded by the plurality of pump fibers, that comprises:
an input section having an input core diameter; and
a first tapered section, adjacent to the input section, in which a core diameter increases from the input core diameter to a maximum value;
tapering a portion of the glass enclosure and a portion of the fiber bundle disposed within the glass enclosure, wherein tapering the portion of the glass enclosure and the portion of the fiber bundle disposed within the glass enclosure causes the signal fiber to further comprise:
an output section having an output core diameter; and
a second tapered section, adjacent to the output section, in which a core diameter decreases from the maximum value to the output core diameter;
cleaving the fiber bundle at the first waist; and
splicing the fiber bundle to an output fiber.

9. The method of claim 8, further comprising:
stripping an optical fiber that comprises a core surrounded by a cladding, wherein the core of the optical fiber has a diameter equal to the maximum value;
tapering the optical fiber such that the optical fiber has a second waist in which a diameter of the core is reduced to match the input core diameter;
cleaving the optical fiber at the second waist to form the first tapered section; and
splicing the first tapered section to the input section to form the signal fiber.

10. The method of claim 8, further comprising:
forming a cladding light stripper on a surface of the glass enclosure; and
tapering a central portion of the glass enclosure to form the first waist.

11. The method of claim 8, further comprising:
etching one or more portions of the glass enclosure.

12. The method of claim 8, wherein:
the input core diameter is equal to the output core diameter, and
the input section of the signal fiber and the output section of the signal fiber have different numerical apertures.

13. The method of claim 8, wherein:
the input section of the signal fiber and the output section of the signal fiber have equal numerical apertures, and
the input core diameter is different from the output core diameter.

14. The method of claim 8, wherein the signal fiber further comprises:
an intermediate section, provided between the first tapered section and the second tapered section, having a uniform core diameter equal to the maximum value.

15. The method of claim 8, wherein the glass enclosure comprises a capillary tube.

16. An optical system, comprising:
an input subsystem comprising:
one or more first laser sources configured to generate signal light; and
a plurality of second laser sources configured to generate pump light;
an output fiber comprising one or more cores configured to carry the signal light and a cladding, surrounding the core, configured to carry the pump light; and
a pump-signal combiner, arranged between the input subsystem and the output fiber, wherein the pump-signal combiner comprises:
a plurality of pump fibers configured to receive the pump light and to transmit the pump light into the cladding of the output fiber; and
one or more signal fibers, surrounded by the plurality of pump fibers, wherein the one or more signal fibers each comprise:
an input section, coupled to the one or more first laser sources, having an input core diameter;
an output section, coupled to the output fiber, having an output core diameter;
a first tapered section, adjacent to the input section, in which a core diameter increases from the input core diameter to a maximum value; and
a second tapered section, adjacent to the output section, in which a core diameter decreases from the maximum value to the output core diameter.

17. The optical system of claim 16, wherein the pump-signal combiner is arranged between the input subsystem and the output fiber in a forward pumping configuration.

18. The optical system of claim 16, wherein the pump-signal combiner is arranged between the input subsystem and the output fiber in a cascaded pumping configuration.

19. The optical system of claim 16, wherein the pump-signal combiner is arranged between the input subsystem and the output fiber in a backward pumping configuration.

20. The optical system of claim 16, wherein the one or more signal fibers each further comprise an intermediate section, provided between the first tapered section and the second tapered section, having a uniform core diameter equal to the maximum value.
